(19) United States
(12) Patent Application Publication
(10) Pub. No.: US 2002/0178046 A1
(43) Pub. Date: Nov. 28, 2002

(54) Product and service risk management clearinghouse

(76) Inventor: David Lawrence, New York, NY (US)

Correspondence Address: Buckley, Maschoff, Talwalkar & Allison LLC, Five Elm Street, New Canaan, CT, 06840, US

(21) Appl. No.: 10/135,623

(22) Filed: Apr. 30, 2002

Related U.S. Application Data
(63) Continuation-in-part of application No. 10/074,584, filed on Feb. 12, 2002.
Application No. 10/074,584 is a continuation-in-part of application No. 10/021,124, filed on Oct. 30, 2001.
Application No. 10/021,124 is a continuation-in-part of application No. 09/812,627, filed on Mar. 20, 2001.

(51) Int. Cl. G06F 17/60

(52) U.S. Cl. 705/10

(57) ABSTRACT

A method and system for managing risk associated with a product or service is provided. Data relevant to regulation can be gathered from multiple sources and aggregated according to risk variables. An inquiry relating to a risk subject can be received and portions of the aggregated data can be associated with the risk subject. A risk subject can include, for example, a product, manufacturer, marketer or other related entity. The associated portions of the aggregated data can be transmitted, such as for example, to a subscriber that submitted the risk subject. Risks related to products or services included in invoices, proposals and the like can also be input for risk management clearing. In addition, an inquiry can include a system to system inquiry involving an individual request or batch screening requests received electronically. Requests can also include a voice communication or a facsimile.

### CROSS REFERENCE TO RELATED APPLICATIONS

This application is a continuation-in-part of a prior application entitled “Risk Management Clearinghouse” filed Feb. 12, 2002 and bearing the Ser. No. 10/074,584, which is a continuation-in-part of a prior application entitled “Risk Management Clearinghouse” filed Oct. 30, 2001, and bearing the Ser. No. 10/021,124, which is also a continuation-in-part of a prior application entitled “Automated Global Risk Management” filed Mar. 20, 2001, and bearing the Ser. No. 09/812,627, all of which are relied upon and incorporated by reference.

### BACKGROUND

This invention relates generally to methods and systems for facilitating the identification, investigation, assessment and management of legal, regulatory, financial and reputational risks (“Risks”). In particular, the present invention relates to computerized systems and methods to compile information relating product recalls, safety warnings, warranty issues and the like and utilizing the compiled information to quantify and manage Risks.

Product safety has become increasingly important for public policy concerns. According to the Consumer Product Safety Commission (CPSC), product recalls have increased in recent years. Recalls may be due to the recognition of increased liability of product manufacturers and vendors and/or because of increased diligence on behalf of government agencies charged with the task of making sure that companies comply with relevant safety laws. Regulators have attempted to address product safety issues by more aggressively enforcing formal and informal obligations upon product manufacturers.

Risks associated with maintaining product safety can include risk factors associated with financial risk, legal risk, regulatory risk and reputational risk. Financial risk can include factors indicative of monetary costs that a product manufacturer, distributor, retailer or other participant in a marketing effort for a particular product or investor may be exposed to as a result of becoming associated with a particular product or company. Monetary costs can be related to fines, forfeitures, costs to defend an adverse position, lost revenue, or other related potential sources of expense.

Regulatory risk can include factors that may cause a product manufacturer or marketer to be in violation of rules put forth by a regulatory agency such as the CPSC, the National Highway Traffic Safety Administration (NHTSA), United States Department of Agriculture (USDA) or other regulatory authority.

Reputational risk relates to harm that a financial institution may suffer regarding its professional standing in the industry. An industry player can suffer from being associated with a situation that may be interpreted as contrary to an image of honesty and forthrightness.

Risks associated with a particular product can be quantified by various and diverse resources. In order to properly assess risks, consumers, compliance officers, investors, product safety managers, marketers and other personnel typically need to continuously reference numerous resources available to identify and assess present or potential risks associated with a particular product, manufacturer, marketer or other related entity.

Those interested in product safety do not have available a mechanism which can provide real time assistance to assess a risk factor associated with a particular product, or otherwise qualitatively manage such risk. In the event of problems arising related to product safety, it is often difficult to quantify to regulatory bodies, shareholders, newspapers and/or other interested parties, the diligence exercised by an affected institution to properly identify and respond to risk factors. Absent a means to quantify good business practices and diligent efforts to contain risk, an affected institution may appear to be negligent in some respect.

What is needed is a method and system to draw upon information gathered globally and utilize the information to assist with risk management and due diligence related to product and services.

### SUMMARY

Accordingly, the present invention teaches a method for managing risk associated with a product or service. Data relevant to the product or service can be gathered into a computer device and aggregated according to risk variables. An indication of a risk subject such as, receipt of a name of a product or service can be received. Portions of the aggregated data can be associated with the risk subject and the associated portions can be transmitted to a designated recipient, such as, for example, a subscriber who indicated what the risk subject included or an interested party designated by the subscriber. Embodiments can include gathered data that is received exclusively from publicly available sources, or proprietary information.

An indication of a risk subject can be received electronically, and can include a system to system inquiry involving batch screening requests. An indication of a risk subject received can also include a facsimile or a voice communication.

In another aspect, a provider of the computer implemented method for managing risk associated with a product or service limit its activities such that it does not create or develop any content included in the aggregated data and therefore avoid any legal complications associated with such activities.

A risk subject can be indicated by any form of communication that makes the risk subject apparent. The risk subject can include, for example, content of an invoice, content of a request for proposal or the content of any other document generated for a user. Typically, the associated portions of the aggregated data are transmitted to a subscriber; however such portions can also be transmitted to an entity designated by a subscriber, or other entity.

In still another aspect, the gathered data related to a product or service can accurately report on or consist of government issued data. A system implementing the method can include an interactive computer service according to the Communications Decency Act.

Embodiments can also include executing an update risk clearinghouse inquiry relating to a risk subject that has been previously searched. Results of the update inquiry can be transmitted to one or more users who had previously received gathered data relevant to the product or service. Additional data relevant to the product or service can be gathered and portions of the additional data associated with the risk subject. The additional data can also be transmitted to a destination to which previously associated data had been transmitted.

In another aspect, a report relating to a subscriber's due diligence efforts can be generated, wherein the report includes the inquiry and the associated portions of the aggregated data.

A risk subject can include data descriptive of one or more of: a product, a product manufacturer, a service provider, and an alert list. The aggregated data can be continually monitored for new information related the risk subject can be transmitted to an appropriate recipient.

In addition, a risk quotient or other a subjective quantification of an amount of risk associated with a particular risk subject can be generated and transmitted to a subscriber or other interested party.

A source of gathered data can also be received and a source of gathered data related to the associated portions of aggregated data can be transmitted to a subscriber or other party, if desired.

Other embodiments of the present invention can include a computerized system, executable software, or a data signal implementing the inventive methods of the present invention. The computer server can be accessed via a network access device, such as a computer. Similarly, the data signal can be operative with a computing device, and computer code can be embodied on a computer readable medium.

In another aspect, the present invention can include a method and system for a user to interact with a network access device so as to manage risk relating to a risk subject. The user can initiate interaction with a proprietary risk management server via a communications network and input information relating to details of the risk subject, such as, for example, via a graphical user interface, and receive back a information related to the risk subject.

Various features and embodiments are further described in the following figures, drawings and claims.

### DESCRIPTION OF THE DRAWINGS

FIG. 1 illustrates a block diagram that can embody this invention.

FIG. 2 illustrates a network of computer systems that can embody an automated RMC risk management system.

FIG. 3 illustrates a flow of exemplary steps that can be executed by a system implementing the present invention.

FIG. 4 illustrates a flow of exemplary steps that can be executed by a system to implement augmented data.

FIG. 5 illustrates a flow of exemplary steps that can taken by a user of the RMC risk management system.

FIG. 6 illustrates an exemplary data structure that can be utilized in conjunction with a RMC risk management system.

FIG. 7 illustrates a graphical user interface that can be utilized in conjunction with a RMC risk management system.

### DETAILED DESCRIPTION

The present invention includes a computerized method and system for managing risk associated with a product or service. A computerized system gathers and stores information as data in a database or other data storing structure and processes the data in preparation for a risk inquiry search relating to product or service concerns, such as: safety issues, recalls or other product liabilities associated with a risk subject, such as a product, manufacturer, marketer or other party. Documents and sources of information can also be stored. A subscriber can submit a description of a risk subject for which a risk inquiry search can be performed. A risk assessment or other inquiry search can include data retrieved resultant to augmented retrieval methods. Scrubbed data as well as augmented data can be transmitted from a risk management clearinghouse (RMC) to a subscriber or to a proprietary risk system utilized by a subscriber, such as a risk management system maintained in-house. Risk inquiry searches can be automated and made a part of standard operating procedure for each transaction conducted by the subscriber.

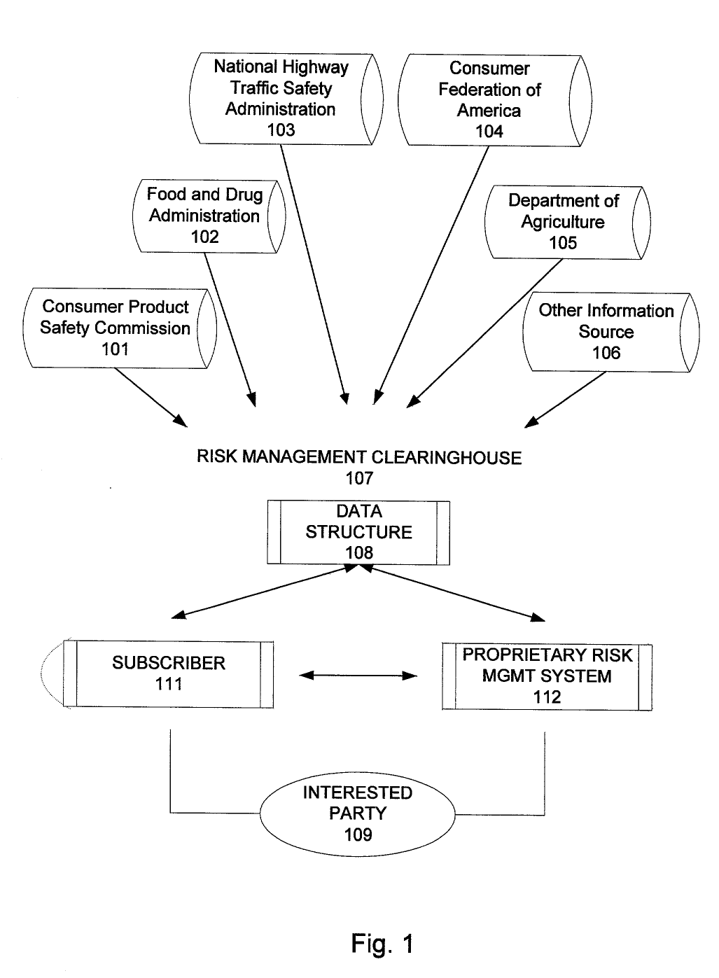

Referring now to FIG. 1 a block diagram of one embodiment of the present invention is illustrated. A RMC system 107 gathers and receives information related to risk variables which are associated with a product, manufacturer, marketer or other product or service related entity. Information may be received, for example, from a list or other reference generated by the CSPC 101, materials provided by the Food and Drug Administration 102, information provided by the NHTSA 103, publications of the Consumer Federation of America (CFA) 104, information provided by the USDA 105, news feeds or other source of risk variable information 106. News articles, and the like, may be particularly important to a subscriber, or other user, since reports regarding particular risk variables associated with products or services often appear in the press before they are officially listed by a governmental or regulatory agency. As such, a news article or a news feed can include any source which makes information available to the public including a news wire, television broadcast, cable news, internet news source, watchdog publications, press releases and the like.

The RMC system 107 can be utilized to retrieve information descriptive of any recalls, product safety warnings, alerts and the like or otherwise facilitate due diligence on the part of a subscriber 111 by gathering, structuring and providing to the subscriber 111 data 108 that relates to risk variables associated with a recall, warning or other product notice. Information can also be made available via the data structure 108 or a generated document according to manufacturer, marketer or other related entity. Embodiments can also include associated data being forwarded to an interested party 109.

A risk variable can be any data which may be indicative of level of risk associated with a particular product or service. Risk variables can include, for exemplary purposes: a product recall for safety reasons; a rating by a government agency or other party relating to product safety; a history of events or fact summaries associated with a product, product type, manufacturer, marketer or other risk subject; legal actions involving a product, manufacturer or other risk subject; medical records associated with the use of a product or participation in a particular activity; or any other information that could be indicative of Risks associated with at product, manufacturer, service provider, marketer or other entity.

Accordingly, gathered information can also include court records or other references relating to product liabilities, product defects, product recalls, substandard or inappropriate service, such as for example a tendency of an automobile to roll over or a firm conducting inappropriate accounting practices. If available, the RMC data 108 can also contain information relating to a size or scope of an identified Risk. For example, information relating to a product recall may include: a number of units affected; price of each unit; the cost of any corrective measures associated with each unit or the entire recall; liabilities associated with the recall, including legal costs, restitution, damages, cost of replacement, and the like; damage to reputation and its impact on future economic factors; costs associated with shipping, stocking products, restocking products; costs associated with technician or other professional time; or other related information.

Of additional interest can be information indicative that an entity is not high risk such as a list of products with high safety ratings, insurance charts indicating relatively safe automobiles or equipment or other sources.

A subscriber 111 can include, for example: a private individual, an investor, business personnel responsible for purchasing goods or services, an insurance provider, a securities analyst, or other person or entity who may be interested in the direct or indirect effects of product or service Risks.

A decision by a subscriber or person receiving product related risk information concerning a product, manufacturer, marketer or other related entity can be dependent upon many factors. A multitude and diversity of Risks related to the factors may need to be identified and evaluated. The weight and commercial implications of the Risk factors and associated direct and indirect Risks can be interrelated. The present invention can provide a consistent and uniform method for business, legal, compliance, credit and other personnel of financial institutions to identify and assess risks associated with a transaction. A RMC system 107 facilitates the identification of risks which can be correlated and quantified by a subscriber to assess legal, regulatory, financial and reputational Risk exposure.

A subscriber 111 institution may, for example, integrate an RMC system 107 to be part of purchasing or activity oversight for various management practices. The RMC system 107 can facilitate sound judgment on the relating to the acquisition of any goods or services. For example, a purchase order system may be scanned, or otherwise monitored, and risk subject inquiries conducted for items or services that are proposed to be purchased. In this manner potential Risks can be identified prior to a manifestation of the potential risks brought about by acquisition or implementation of a risk subject.

In this manner, an individual, institution, organization or other entity can proactively take steps to identify Risks and take appropriate steps to address identified Risks. In addition, the individual, institution, organization or other entity can also quantify steps risk subject inquiries that support the acquisition of products or services, or other actions taken, as a result, in part, to a favorable finding of a risk subject inquiry.

A query can also be automatically generated from monitoring information gleaned from normal business practices being conducted by a subscriber 111. For example, an information system can electronically scan transaction data for key words, product names, service types, or other pertinent data. Programmable software can be utilized to formulate a query according to a product or service or other pertinent data, and run the query against a database maintained by the RMC system 107. Other methods can include voice queries via a telephone or other voice line, such as voice over internet, fax, electronic messaging, or other means of communication. A query can also include direct input into a RMC system 107, such as through a graphical user interface (GUI) with input areas or prompts.

Prompts or other questions proffered by the RMC system 107 can also depend from previous information received. Information generally received, or received in response to the questions, can be input into the RMC system 107 from which it can be utilized for real time risk assessment and generation of a risk quotient 108.

In addition to product or service acquisition, due diligence inclusive of a RMC 107 risk inquiry search can also facilitate decisions relating to a variety of activities and decision making processes. For example, a search for Risks related to a product, brand name, service, organization, or other product oriented risk inquiry can facilitate judgment relating to investment in a security or company, association with a particular entity, lending practices based upon collateral, or other Risk associated practice.

Embodiments can also include an RMC system 107 which operates an interactive computer service as that term is defined in the CDA. The RMC 107 can therefore provide an information service and/or access software that enables computer access by multiple users to a computer server. In some embodiments, if desired, an RMC system 107 provider can limit its employees or agents from creating or developing any of the content in the RMC database 108. Content be maintained unchanged except that the RMC system 107 can remove information from the database that it determines to be inaccurate or irrelevant.

Embodiments can also include utilizing a RMC system 107 to substantiate a provider certification which indicates that a risk inquiry has been conducted relating to all products or services provided, or to be provided, as listed on an invoice, proposal, or other document which contains a list of products or services. For example, a provider certification can accompany an invoice for products that states that each product listed on the invoice has been the subject of an RMC 107 risk inquiry and a statement that no negative responses were received as a result of the inquiry. Additionally, if desired, actual results, including documents or other artifacts identified via a risk inquiry or other search can be forwarded to a receiver of products or services. For example, artifacts can be included with an invoice or provider certification. Embodiments can also include making the inquiry criteria available for the perusal and records of a recipient of the goods or services, such as transmitting to a consumer any related materials discovered as a result of the inquiry. Some embodiments can include transmitting materials relating to a hedge fund risk inquiry without any value judgment or other rating associated with the inquiry or the subject hedge fund.

Such risk inquiries related to products or services provided can also be performed or updated on a periodic basis. If the results of an update inquiry indicate a substantive change over what had been previously provided to a receiver of products or services, the updated inquiry results can also be forwarded to the receiver of goods or services. For example, if a particular product is sold to a customer, the customer may receive a provider certification indicating that at risk inquiry performed by a RMC 107 has not returned any detrimental information relating to any of the goods or services received by the customer. However, perhaps a subsequent update inquiry indicates that six months after the customer received an invoiced product; the product was the subject of a recall. The provider can then provide notification of the recall to the customer.

The exemplified system can similarly be utilized for products or services that are not shipped or otherwise provided but are the subject of a request for proposal, quote, or other indication of interest. Automated systems can be utilized to capture key words or other references to products and services which are the subject of a subscriber's business and automatically transmit captured references to an RMC 107 for a clearinghouse inquiry search. Transmission can be accomplished according to any arrangement suitable, such as, for example: on a continual basis, at periodic intervals, as needed, in a batch format, individually for each risk subject, or any other system or arrangement that fits a particular set of circumstances.

In addition, embodiments can include a risk quotient or other rating that can provide a subjective quantification of an amount of risk associated with a particular risk subject, such as a particular good or service ordered.

Information gathered from the diversity of data sources can be aggregated into a searchable data storage structure 108. A source of information can also be received and stored. In some instances a subscriber 111 may wish to receive information regarding the source of information received. Gathering data into an aggregate data structure 108, such as a data warehouse, can allow a RMC system 107 to have the data 108 readily available for processing a risk management search associated with a risk subject. Aggregated data 108 can also be scrubbed or otherwise enhanced. Enhanced data can often relieve a subscriber from having to submit multiple search terms relating to a risk subject and allow a RMC 107 inquiry to be more comprehensive. Sophisticated data searching technology can be utilized to locate and organize data related to a risk subject.

Embodiments can therefore include data scrubbing to implement a data warehouse comprising the aggregate data structure 108. The data scrubbing can associate information from multiple databases and store the information in a manner that gives faster, easier and more flexible access to key facts. Scrubbing can facilitate expedient access to accurate data commensurate with the critical business decisions that will be based upon the risk management assessment provided.

Various data scrubbing routines can be utilized to facilitate aggregation of risk variable related information. The routines can include programs capable of correcting a specific type of mistake, such as an incomprehensible address, or clean up a full spectrum of commonly found database flaws, such as field alignment that can pick up misplaced data and move it to a correct field or removing inconsistencies and inaccuracies from like data.

For example, a scrubbing routine can be used to facilitate various different spelling of a term or a name. In particular, spelling of names can be important when names have been translated from a foreign language into English. For example, languages can include different alphabets. Translations between languages can create variations as alphabet substitutes are implemented. A data scrubbing routine can facilitate risk variable searching for multiple spellings of an equivalent name or other important information. Such a routine can enhance the value of the aggregate data gathered and also help correct database flaws. Scrubbing routines can improve and expand data quality more efficiently than manual mending and also allow a subscriber 111 to quantify best practices for regulatory purposes.

Retrieving information related to risk variables from the aggregated data can also be an operation with a goal of fulfilling a given a request. In order to process a request against a large document set of aggregated risk data with a response time acceptable to the user, it may be necessary to utilize an index based approach to facilitate acceptable response times. A direct string comparison based search may be unsuitable for the task.

An index file for a collection of documents can therefore be built upon receipt of the new data and prior to a query or other request. The index file can include a pointer to the document and also include important information contained in the documents the index points to. At query time, the RMC system 107 can match a query against a representation of the documents, instead of the documents themselves. The RMC system 107 can retrieve the documents referenced by the indexes that satisfy the request if the subscriber submits such a request. However it may not be necessary to retrieve the full document as index records may also contain the relevant information gleaned from the documents they point to. This allows the user to extract information of interest without having to read the source document.

Augmenting data can include data mining techniques that use sophisticated software to analyze and sift through the aggregated data stored in the warehouse using techniques such as mathematical modeling, statistical analysis, pattern recognition, rule based trends or other data analysis tools. In contrast to traditional systems that may have gathered and stored information in a flat file and regurgitated the stored information when requested, such as in a defined report related to a specific risk subject or other ad hoc access concerned with a particular query at hand, the present invention can provide risk related searching that adds a discovery dimension by returning results that a human operator may find labor and cognitively intense.

Information entered by a subscriber into a PRM system 112 may be information gathered according to normal course of dealings with a particular entity or as a result of a concerted investigation. In addition, since the PRM system 112 is proprietary and a subscriber responsible for the information contained therein can control access to such information. A PRM system 112 can include information that is public or proprietary. If desired, information entered into the PRM system 112 can be shared with a RMC system 107. Informational data can be shared, for example via an electronic transmission or transfer of electronic media. However, RMC system 107 data may be subject to applicable local or national law and safeguards should be adhered to in order to avoid violation of such law through data sharing practices.

A log or other stored history can be created by the RMC system 107 and/or a PRM system 112, such that utilization of the system can mitigate adverse effects relating to a problematic Risk. Mitigation can be accomplished by demonstrating to regulatory bodies, shareholders, news media and other interested parties that corporate governance is being addressed through tangible risk management processes.

Embodiments can also include an alert list containing names, descriptions, terms of interest, or other descriptors supplied to the RMC system 107 by a subscriber 111 or other source. An alert list can be standardized, or customized and specific to a subscriber 111. The RMC system 107 can continually monitor data in its database via an alert query with key word, fuzzy logic or other search algorithms and transmit related informational data to an interested party. In this manner, ongoing diligence can be conducted. In the event that new information is uncovered by an alert query, an interested subscriber 111 can be immediately notified, or notified according to a predetermined schedule. Appropriate action can be taken according to the information uncovered.

The RMC system 107 can quantify risk due diligence by capturing and storing a record of information received and actions taken relating to a product, manufacturer, marketer or other related entity. Once quantified, the due diligence data can be utilized for presentation, as appropriate, to regulatory bodies, shareholders, news media and/or other interested parties, such presentation may be useful to mitigate adverse effects relating to a problematic transaction. The data can demonstrate that corporate governance is being addressed through tangible risk management processes.

A subscriber 111 to the RMC system 107 will be able to access the database electronically and to receive relevant information electronically and, in specific circumstances, hard copy format. If requested, an RMC system 107 provider can alert a subscriber 111 upon its receipt of new RMC system 107 entries concerning a previously screened risk subject.

A subscriber 111 can be permitted to access information in the RMC system 107 in various ways, including, for example: system to system inquires involving single or batch screening requests, individual inquiries (submitted electronically, by facsimile, or by phone) for smaller screening requests, or through a web-based interface supporting an individual look-up service.

In still another aspect, an RMC system 107 can be structured to take advantage of the immunity from liability for libel and slander granted by the Communications Decency Act (“CDA”) to providers of interactive computer services. Where its operations are not protected by the CDA, an RMC system 107 may be able to reduce its risk of liability for defamation substantially by relying only on official sources and other reputable sources, and taking particular care with defamatory information from unofficial sources. In addition the RMC system 107 provider can take reasonable steps to assure itself of the information's accuracy, including insuring that the source of the information is reputable.

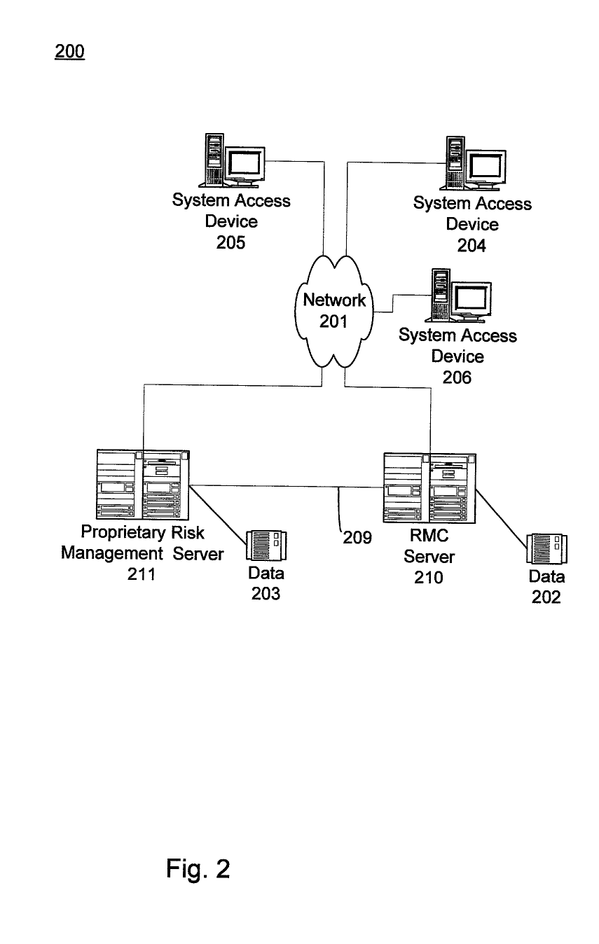

Referring now to FIG. 2, a network diagram illustrating one embodiment of the present invention is shown 200. An automated RMC 107 can include a computerized RMC server 210 accessible via a distributed network 201 such as the Internet, or a private network. A subscriber, or other party interested in risk management, can use a computerized system or network access device 204-206 to receive, input, transmit or view information processed in the RMC server 210. A protocol, such as the transmission control protocol internet protocol (TCP/IP) can be utilized to provide consistency and reliability.

In addition, a PRM server 211 can access the RMC server 210 via the network 201 or via a direct link 209, such as a T1 line or other high speed pipe. The PRM server 211 can be accessed, in turn, by a user via a system access device 204-206 and a communications network 201, such as a local area network, or other private network, or even the Internet, if desired.

A computerized system or system access device 204-206 used to access the RMC server 210 or the PRM server 211 can include a processor, memory and a user input device, such as a keyboard and/or mouse, and a user output device, such as a display screen and/or printer. The system access devices 204-206 can communicate with the RMC server 210 or the PRM server 211 to access data and programs stored at the respective servers 210-211. The system access device 204-206 can interact with a RMC server 210 as if the RMC risk server 210 were a single entity in the network 200. However, the server 210 may include multiple processing and database sub-systems, such as cooperative or redundant processing and/or database servers that can be geographically dispersed throughout the network 200.

The RMC server 210 includes one or more databases 202 storing data relating to risk management. The RMC server 210 may interact with and/or gather data from an operator of a system access device 204-206 or other source, such as from the RMC server 210. Data received may be structured according to risk criteria and utilized to calculate a risk quotient 108.

Typically a subscriber 111 or other user will access the RMC server 210 using client software executed at a system access device 204-206. The client software may include a generic hypertext markup language (HTML) browser, such as Netscape Navigator or Microsoft Internet Explorer, (a “WEB browser”). The client software may also be a proprietary browser, and/or other host access software. In some cases, an executable program, such as a Java™ program, may be downloaded from the RMC server 210 to network access device 204-206 and executed at the system access device 204-206 or other computer as part of the RMC risk management software. Other implementations include proprietary software installed from a computer readable medium, such as a CD ROM.

The present invention may therefore be implemented in digital electronic circuitry, computer hardware, firmware, software, or in combinations of the above. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

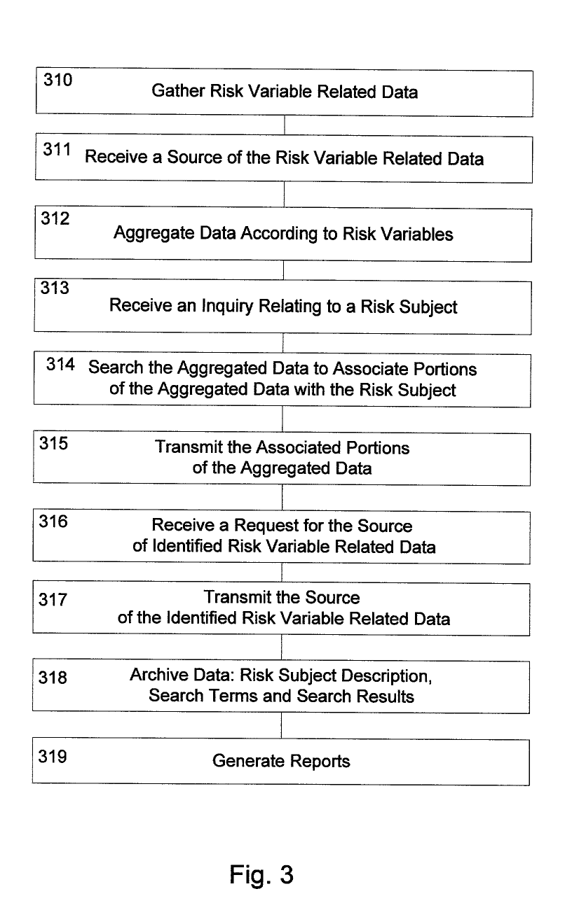

Referring now to FIG. 3, steps taken to manage risk associated with a product, manufacturer, marketer or other related entity can include gathering data relating to Risks and risk variables 310 and receiving the gathered information into an RMC server 210. Informational data can be gathered from any available source including a source of electronic data such as an external database, messaging system, news feed, government agency, or any other automated data provider. Typically, the RMC server 210 will receive data relating to a product, manufacturer, marketer or other related subject. Information can be received on an ongoing basis such that if new events occur in the world that affect the product, manufacturer, marketer or other related entity, a calculated risk can be adjusted accordingly.

A source of risk variable data can also be received 311 by the RMC server 210 or other provider of risk management related data. For example, a source of risk variable data may include a government agency, such as the CSPC 101, the FDA 102, the NHTSA 103, the USDA 105, or other source of risk variable information. Other sources can include an investigation firm, public records, news reports, other government and non-government organizations, internet websites, news feeds, commercial databases, or other information sources.

The RMC server 210 can aggregate the data received according to risk variables 312 or according to any other data structure conducive to fielding Risk.

All data received can be combined and aggregated 312 to create an aggregate source of data which can be accessed to perform risk management activities. Combining data can be accomplished by any known data manipulation method. For example, the data can be maintained in separate tables and linked with relational linkages, or the data can be gathered into on comprehensive table or other data structure. The RMC server 210 can receive an inquiry relating to a risk subject 313. The risk subject can be any subject related to the variables discussed above, for example, a risk subject can include product, a service, a manufacturer, a marketer, a supplier for a product, an industry or other related information.

The inquiry from a subscriber, or other authorized entity, can cause a server 210-211 to search aggregated data and associate related portions of the aggregated data with the risk subject 314. The associated portions of aggregated data can be transmitted 315 to a party designated by the requesting subscriber.

The RMC server 210 may also receive a request for the source of particular risk variable related data 316, in which case, the RMC server 210 can transmit the source of the identified risk variable related data to the requester 317. The source may be useful in adding credibility to the data, or to follow up with to request additional information.

The RMC server 210 can also store in memory, or otherwise archive risk management related data and proceedings 318. Archived risk management related data and proceedings can be useful to quantify corporate governance and diligent efforts to address high risk situations. Accordingly, reports quantifying RMC risk management risk management procedures, executed due diligence, corporate governance or other matters can be generated 319.

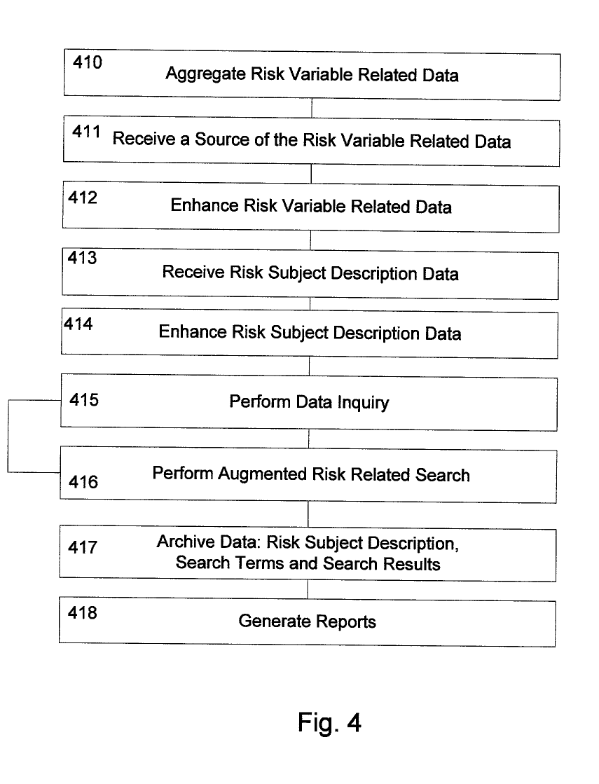

Referring now to FIG. 4, the present invention can also include steps that allow an RMC server 210 or PRM server 211 to provide data augmenting functionality that allows for more accurate processing of data related to Risk management. Accordingly, a RMC server 210 or PRM server 211 can aggregate risk variable related data 410 and also the source of the risk variable related data 411. The RMC server 210 or PRM server 211 can also enhance the risk variable related data, such as through data scrubbing techniques or indexing. A risk subject description can also be received 413 and scrubbed or otherwise enhanced 414.

An inquiry can be performed against the aggregated and enhanced data 415. In addition, an augmented search that incorporates data mining techniques 416 can be included to further expand the depth of knowledge retrieved by the inquiry. If desired, a new inquiry can be formed as a result of the augmented search. This process can continue until the inquiry and augmentation ceases to add any additional meaningful value. Searching and augmentation steps can be archived 417 and reports generated to quantify due diligence efforts 418.

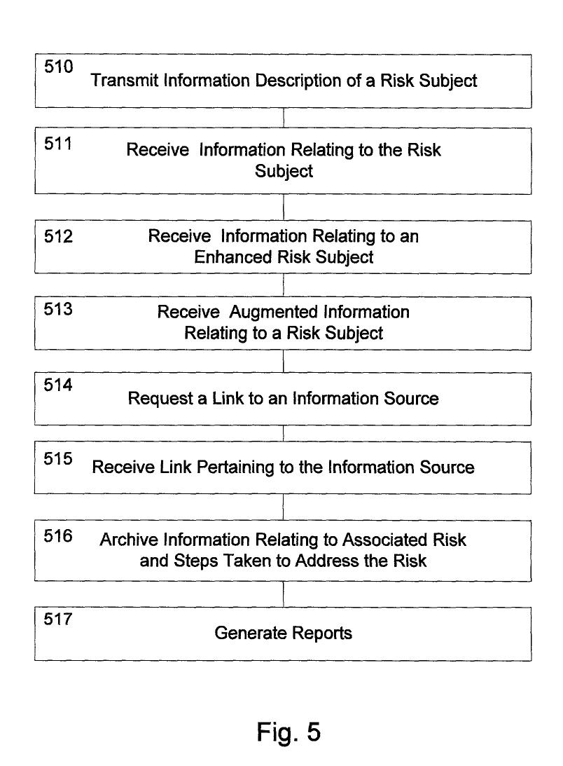

Referring now to FIG. 5, a flow chart illustrates steps that a user, such as a subscriber 111, can implement to manage Risks associated with a product or service. The user can input, or otherwise indicate to a RMC server 210, a description of a risk subject, such as the name of a product or the name of the provider of a service 510.

Access can be accomplished, for example, by opening a dialogue with an RMC server 210 with a network access device, 204-206. Typically, the dialogue would be opened by presenting a GUI to a network access device 204-206. The GUI will be capable of accepting data input via the network access device 204-206. An example of a GUI can include a series of questions relating to a product, service or provider. Alternatively, information can be received directly into fields of a database, such as from a program that scans data contained in normal business processes, such as a purchase order or invoicing system.

Embodiments can include automated monitoring software which runs in the background of a normal business software program to screen data traversing an application. The screened data can be processed to determine key words wherein the key words can in turn be presented to the RMC server 210 as risk subjects or risk variables. Other embodiments can include capturing fields, table cells, or the like used to populate an invoice or other document in order to identify key words. The RMC server 210 will process the key words to identify entities or other risk variables. Monitoring software can also be installed to screen data traversing a network or communications link.

The subscriber 111 or other user can receive information relating to Risks associated with the risk subject product, process, or provider 512. The information can include enhanced data, such as scrubbed data. In some embodiments, a user can receive the results of a risk inquiry search relating to ongoing monitoring of key words. Updated information or change in status detected via an ongoing monitoring can result in an alarm or other alert being sent to one or more appropriate users.

The subscriber 111 or other user can also receive augmented information 513, such as data that has been processed through data mining techniques discussed above.

In addition to receiving augmented information 513, a user can request an identifier of a source of information obtained as a result of a risk inquiry, such as a link to a source of information 514. Receipt of a link pertaining to a source of information 515 may be useful to pursue more details relating to the information, or may be utilized to help determine the credibility of the information received.

A user can also cause an archive to be created relating to the risk management 516. An archive may include, for example, information received relating to risk associated with a product or service, inquiries made and results of each inquiry. In addition, the user can cause an RMC 107 to generate reports to quantify the archived information and otherwise document diligent actions taken relating to risk management 517.

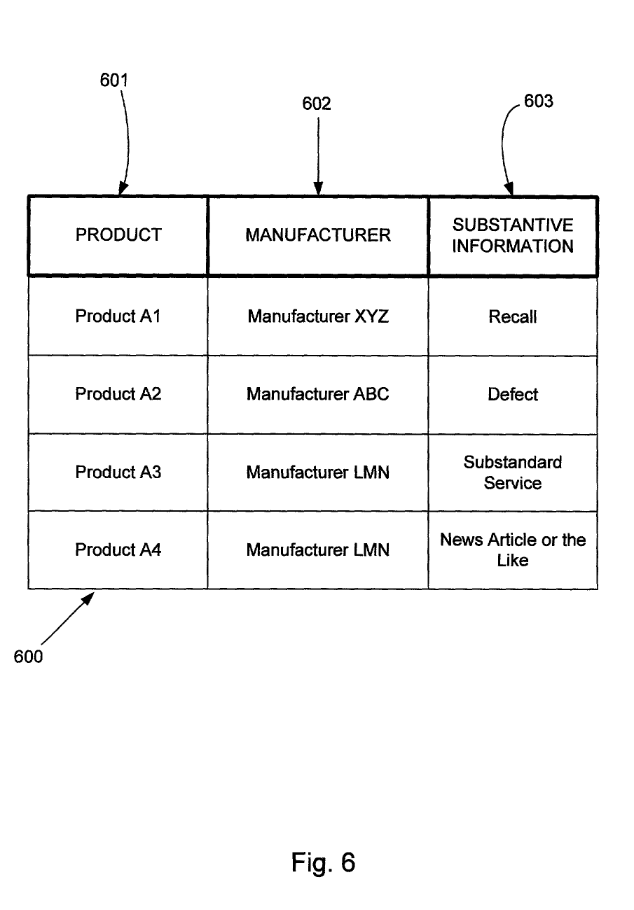

Referring now to FIG. 6 a database structure 600 that can be useful for implementing the present invention is presented. Data fields can include, for example, a product field 601, a manufacturer filed 602 and a substantive information field 603 that can contain information relating to recalls, defects, substandard service or other issues.

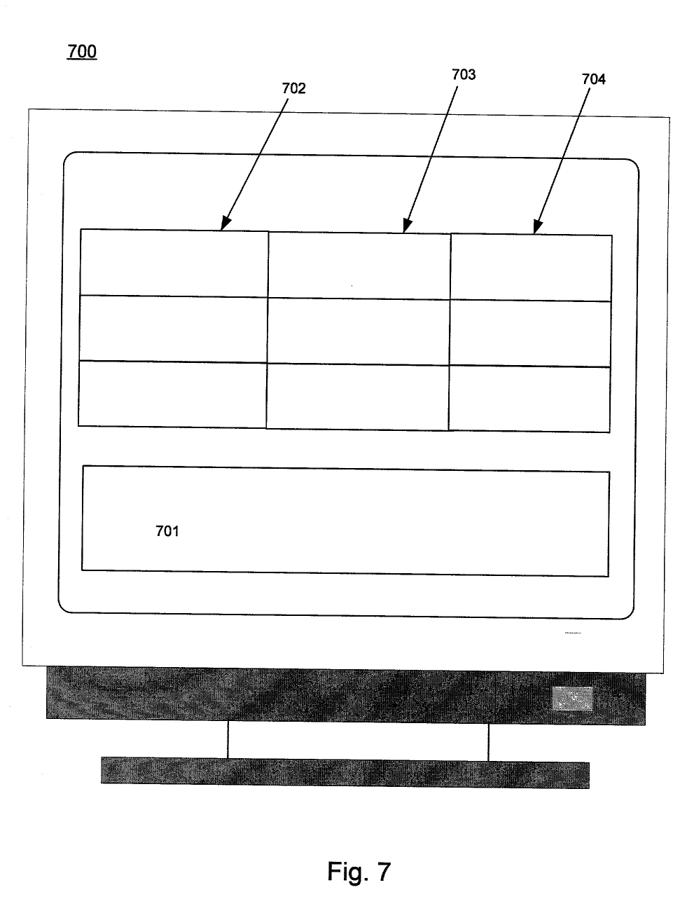

Referring now to FIG. 7, a GUI that may be useful in implementing the present invention is illustrated. The GUI can include an interactive area for inputting a risk subject, such as a product or service description 702, a subscriber 111 name or other user identifier 703, a date range 704, descriptive text 701 or other information.

A number of embodiments of the present invention have been described. Nevertheless, it will be understood that various modifications may be made without departing from the spirit and scope of the invention. For example, network access devices 204-206 can comprise a personal computer executing an operating system such as Microsoft Windows™, Unix™, or Apple Mac OS™, as well as software applications, such as a JAVA program or a web browser. A network access devices 204-206 can also be a terminal device, a palm-type computer, mobile WEB access device, a TV WEB browser or other device that can adhere to a point-to-point or network communication protocol such as the Internet protocol. Computers and network access devices can include a processor, RAM and/or ROM memory, a display capability, an input device and hard disk or other relatively permanent storage. Accordingly, other embodiments are within the scope of the following claims.

What is claimed is:

1. A computer-implemented method for managing risk associated with a product or service, the method comprising:
gathering data relevant to the product or service into a computer device;
aggregating the data gathered according to risk variables;
receiving an indication of a risk subject;
associating portions of the aggregated data with the risk subject; and
transmitting the associated portions of the aggregated data.

2. The method of claim 1 wherein the gathered data is gathered exclusively from publicly available sources.

3. The method of claim 1 wherein the indication received comprises a system to system inquiry involving batch screening requests.

4. The method of claim 1 wherein the indication received comprises an inquiry received electronically.

5. The method of claim 1 wherein the indication of a risk subject received comprises an inquiry received via facsimile.

6. The method of claim 1 wherein the inquiry received comprises an inquiry received via voice communication.

7. The method of claim 1 wherein a provider of the computer implemented method for managing risk associated with a product or service does not create or develop any content included in the aggregated data.

8. The method of claim 1 wherein the indication of a risk subject comprises content of an invoice.

9. The method of claim 1 wherein the indication of a risk subject comprises content of a request for proposal.

10. The method of claim 1 wherein the associated portions of the aggregated data are transmitted to a subscriber.

11. The method of claim 1 wherein the associated portions of the aggregated data are transmitted to an entity designated by a subscriber.

12. The method of claim 1 wherein the gathered data related to a product or service accurately reports on or consists of government issued data.

13. The method of claim 1 wherein the computer-implemented method for managing risk associated with a product or service comprises an interactive computer service according to the Communications Decency Act.

14. The method of claim 1 wherein none of the associated portions of the aggregated data transmitted comprises any content created or developed by a provider of the computer-implemented method for managing risk associated with a product or service.

15. The method of claim 1 additionally comprising the steps of: p1 executing an update risk clearinghouse inquiry relating to a risk subject that has been previously searched; and
transmitting results of the inquiry to one or more users who had previously received gathered data relevant to the product or service.

16. The method of claim 1 additionally comprising the step of generating a report relating to a subscriber's due diligence efforts, wherein the report comprises the inquiry and the associated portions of the aggregated data.

17. The method of claim 1 additionally comprising the steps of:
gathering additional data relevant to the product or service;
associating portions of the additional data with the risk subject; and
transmitting the additional data to a destination to which previously associated data had been transmitted.

18. The method of claim 1 wherein the risk subject comprises data descriptive of one or more of: a product, a product manufacturer, and a service provider.

19. The method of claim 1 wherein the indication of a risk subject comprises an alert list.

20. The method of claim 19 additionally comprising the steps of continually monitoring the aggregated data and transmitting any new information related the risk subject.

21. The method of claim 1 additionally comprising the step of generating a subjective quantification of an amount of risk associated with a particular risk subject.

22. The method of claim 1 additionally comprising the step of enhancing the gathered data.

23. The method of claim 22 additionally comprising the step of enhancing the data descriptive of the risk subject.

24. The method of claim 22 or 23 wherein enhancing the data comprises scrubbing the data to incorporate changes in the spelling of the risk subject.

25. The method of claim 1 additionally comprising the steps of receiving a source of gathered data and transmitting the source of gathered data related to the associated portions of aggregated data.

26. The method of claim 1 wherein a source of gathered data comprises a news article.

27. The method of claim 1 wherein a source of gathered data comprises a news feed.

28. The method of claim 1 wherein a source of gathered data comprises a government publication.

29. A computerized system for managing risk, the system comprising:
a computer server accessible with a system access device via a communications network; and
executable software stored on the server and executable on demand, the software operative with the server to cause the system to:
gather data relevant to the product or service into a computer device;
aggregate the data gathered according to risk variables;
receive an indication of a risk subject;
associate portions of the aggregated data with the risk subject; and
transmit the associated portions of the aggregated data.

30. The computerized system of claim 29 wherein the data is gathered via an electronic feed.

31. Computer executable program code residing on a computer-readable medium, the program code comprising instructions for causing the computer to:
gather data relevant to the product or service into a computer device;
aggregate the data gathered according to risk variables;
receive an indication of a risk subject;
associate portions of the aggregated data with the risk subject; and
transmit the associated portions of the aggregated data.

32. A computer data signal embodied in a digital data stream comprising data relating to risk management, wherein the computer data signal is generated by a method comprising the steps of:
gathering data relevant to the product or service into a computer device;
aggregating the data gathered according to risk variables;
receiving an indication of a risk subject;
associating portions of the aggregated data with the risk subject; and
transmitting the associated portions of the aggregated data.
